(19) United States
(12) Patent Application Publication
(10) Pub. No.: US 2022/0126881 A1
(43) Pub. Date: Apr. 28, 2022

(54) ELECTRONIC DEVICE AND OPERATING METHOD OF ELECTRONIC DEVICE

(71) Applicant: LG ELECTRONICS INC., Seoul (KR)

(72) Inventors: Soonhong JUNG, Seoul (KR); Taeseok LEE, Seoul (KR); Chaehwan LEEM, Seoul (KR)

(73) Assignee: LG ELECTRONICS INC., Seoul (KR)

(21) Appl. No.: 16/490,008

(22) PCT Filed: Jul. 4, 2019
(86) PCT No.: PCT/KR2019/008199

§ 371 Date: Aug. 29, 2019

(51) Int. Cl. B60W 60/00; B60L 53/57; B60L 58/12; G05B 19/4155

(52) U.S. Cl. CPC B60W 60/00256; B60L 53/57; B60W 2510/244; G05B 19/4155; G05B 2219/50391; B60L 58/12

(57) ABSTRACT

The present invention relates to an operating method of an electronic device including: acquiring, by at least one processor, movement path data of at least one sub mobile body loaded in a main mobile body; receiving, by at least one processor, first residual energy amount information of the sub mobile body in a state in which the sub mobile body is loaded in the main mobile body; determining, by at least one processor, a recharging amount based on the movement path data and the first residual energy amount information; and providing, by at least one processor, a control signal to enable the sub mobile body to be recharged to the determined recharging amount. The main mobile body may be an autonomous vehicle to move along a global path, and the sub mobile body may be an article delivery robot to move a local path. The autonomous vehicle and the mobile robot may exchange data using a 5G communication system. The autonomous vehicle and the mobile robot may use an artificial intelligence (AI) algorithm. The autonomous vehicle and the mobile robot may produce augmented reality (AR) contents.

### TECHNICAL FIELD

The present invention relates to an electronic device and an operating method of the electronic device.

### BACKGROUND ART

A vehicle is an apparatus movable in a desired direction by a user seated therein. A representative example of such a vehicle is an automobile. An autonomous vehicle means a vehicle which can automatically travel without manipulation of a person.

Robots have been developed for industrial purposes and, as such, have partially taken part in factory automation. Recently, fields to which robots are applied have been further expanded. As such, medical robots, aerospace robots, etc. have been developed. Home service robots usable in homes have also been developed. Among such robots, a robot, which is autonomously movable, is referred to as a “mobile robot”.

In recent years, a technology for delivering articles using an autonomous vehicle and a mobile robot has been developed. The autonomous vehicle and the mobile robot move on the basis of limited energy and, as such, efficient energy management is required.

### DISCLOSURE

### Technical Problem

Therefore, the present invention has been made in view of the above problems, and it is an object of the present invention to provide an operating method of an electronic device capable of achieving efficient energy management of a main mobile body and a sub mobile body.

It is another object of the present invention to provide an electronic device capable of achieving efficient energy management of a main mobile body and a sub mobile body.

Objects of the present invention are not limited to the above-described objects, and other objects of the present invention not yet described will be more clearly understood by those skilled in the art from the following detailed description.

### Technical Solution

In accordance with an aspect of the present invention, the above objects can be accomplished by the provision of an operating method of an electronic device including: acquiring, by at least one processor, movement path data of at least one sub mobile body loaded in a main mobile body; receiving, by at least one processor, first residual energy amount information of the sub mobile body in a state in which the sub mobile body is loaded in the main mobile body; determining, by at least one processor, a recharging amount based on the movement path data and the first residual energy amount information; and providing, by at least one processor, a control signal to enable the sub mobile body to be recharged to the determined recharging amount.

In accordance with an embodiment of the present invention, the main mobile body may be an autonomous vehicle to move along a global path, and the sub mobile body may be an article delivery robot to move a local path.

In accordance with an embodiment of the present invention, the acquiring may include acquiring, by at least one processor, residual delivery article information, and producing the movement path data based on the residual delivery article information.

In accordance with an embodiment of the present invention, the residual delivery article information may include information as to the number of residual delivery articles and information as to delivery places of the residual delivery articles.

In accordance with an embodiment of the present invention, the operating method of the electronic device may further include: determining, by at least one processor, a sub mobile body to be recharged from among a plurality of sub mobile bodies.

In accordance with an embodiment of the present invention, the determining a sub mobile body to be recharged may include: acquiring, by at least one processor, information as to an amount of energy required during movement of each sub mobile body from a predetermined unloading point thereof to a target point thereof; and determining, by at least one processor, a sub mobile body to be recharged based on the required energy amount and the first residual energy amount information.

In accordance with an embodiment of the present invention, the operating method of the electronic device may further include: providing, by at least one processor, as the movement path data, data as to a movement path from a predetermined unloading point of the sub mobile body to a target point of the sub mobile body.

In accordance with an embodiment of the present invention, the operating method of the electronic device may further include: receiving, by at least one processor, second residual energy amount information of the sub mobile body in an unloaded state of the sub mobile body; determining, by at least one processor, whether or not the sub mobile body can arrive at the target point, based on the second residual energy amount information; and providing, by at least one processor, a path for returning the sub mobile body to the main mobile body upon determining that the sub mobile body cannot arrive at the target point.

In accordance with an embodiment of the present invention, the operating method of the electronic device may further include: providing, by at least one processor, as the movement path data, data as to a movement path from the target point to a predetermined loading point of the sub mobile body.

In accordance with an embodiment of the present invention, the operating method of the electronic device may further include: receiving, by at least one processor, second residual energy amount information of the sub mobile body in an unloaded state of the sub mobile body; determining, by at least one processor, whether or not the sub mobile body can arrive at the predetermined loading point, based on the second residual energy amount information; and changing, by at least one processor, the predetermined loading point upon determining that the sub mobile body cannot arrive at the predetermined loading point.

In accordance with an embodiment of the present invention, the operating method of the electronic device may further include: comparing, by at least one processor, the recharging amount with an energy amount which can be provided by the main mobile body; and creating, by at least one processor, a path for movement of the main mobile body to a recharging station upon determining that the recharging amount is greater than the energy amount which can be provided.

In accordance with an embodiment of the present invention, the operating method of the electronic device may further include: generating, by at least one processor, a control signal to unload the sub mobile body upon determining that the recharging amount is greater than the energy amount which can be provided.

In accordance with an embodiment of the present invention, the determining a recharging amount may include: acquiring, by at least one processor, information as to a required energy amount needed for movement of the main mobile body to a recharging station thereof; and determining, by at least one processor, the recharging amount, further based on the acquired required energy amount.

In accordance with another aspect of the present invention, there is provided an electronic device including: a processor for acquiring movement path data of at least one sub mobile body loaded in a main mobile body, receiving first residual energy amount information of the sub mobile body in a state in which the sub mobile body is loaded in the main mobile body, determining a recharging amount based on the movement path data and the first residual energy amount information, and providing a control signal to enable the sub mobile body to be recharged to the determined recharging amount.

In accordance with an embodiment of the present invention, the main mobile body may be an autonomous vehicle to move along a global path, and the sub mobile body may be an article delivery robot to move a local path.

In accordance with an embodiment of the present invention, the processor may acquire residual delivery article information, and may produce the movement path data based on the residual delivery article information.

In accordance with an embodiment of the present invention, the residual delivery article information may further include information as to the number of residual delivery articles and information as to delivery places of the residual delivery articles.

In accordance with an embodiment of the present invention, the processor may determine a sub mobile body to be recharged from among a plurality of sub mobile bodies.

In accordance with an embodiment of the present invention, the processor may acquire information as to an amount of energy required during movement of each sub mobile body from a predetermined unloading point thereof to a target point thereof, and may determine a sub mobile body to be recharged based on the required energy amount and the first residual energy amount information.

In accordance with an embodiment of the present invention, the processor may provide, as the movement path data, data as to a movement path from a predetermined unloading point of the sub mobile body to a target point of the sub mobile body.

Concrete matters of other embodiments will be apparent from the detailed description and the drawings.

### Advantageous Effects

In accordance with the present invention, one or more effects are provided as follows.

Efficient energy management of a main mobile body and a sub mobile body may be possible and, as such, there is an effect of effectively achieving delivery of a desired article.

The effects of the present invention are not limited to the above-described effects and other effects which are not described herein may be derived by those skilled in the art from the following description of the embodiments of the disclosure.

### DESCRIPTION OF DRAWINGS

FIG. 1A is a view illustrating an appearance of a vehicle according to an embodiment of the present invention.

FIG. 1B is a control block diagram of the vehicle according to an embodiment of the present invention.

FIG. 2 is a view referred to for explanation of a system according to an embodiment of the present invention.

FIG. 3 is a control block diagram of the electronic device according to an embodiment of the present invention.

FIG. 4 is a flowchart of the electronic device according to an embodiment of the present invention.

FIGS. 5 and 6 are views referred to for explanation of operation of the electronic device according to an embodiment of the present invention.

### BEST MODE

Reference will now be made in detail to the exemplary embodiments of the present invention, examples of which are illustrated in the accompanying drawings. Identical or similar constituent elements will be designated by the same reference numeral even though they are depicted in different drawings. The suffixes “module” and “unit” of elements herein are used for convenience of description and thus can be used interchangeably, and do not have any distinguishable meanings or functions. In the following description of the at least one embodiment, a detailed description of known functions and configurations incorporated herein will be omitted for the purpose of clarity and for brevity. The features of the present invention will be more clearly understood from the accompanying drawings and should not be limited by the accompanying drawings, and it is to be appreciated that all changes, equivalents, and substitutes that do not depart from the spirit and technical scope of the present invention are encompassed in the present invention.

It will be understood that, although the terms “first”, “second”, “third” etc. may be used herein to describe various elements, these elements should not be limited by these terms. These terms are only used to distinguish one element from another element.

It will be understood that, when an element is referred to as being “connected to” or “coupled to” another element, it may be directly connected or coupled to the other element, or intervening elements may be present. In contrast, when an element is referred to as being “directly connected to” or “directly coupled to” another element or layer, there are no intervening elements present.

The singular expressions in the present specification include the plural expressions unless clearly specified otherwise in context.

It will be further understood that the terms “comprises” or “comprising” when used in this specification specify the presence of stated features, integers, steps, operations, elements, or components, but do not preclude the presence or addition of one or more other features, integers, steps, operations, elements, components, or groups thereof.

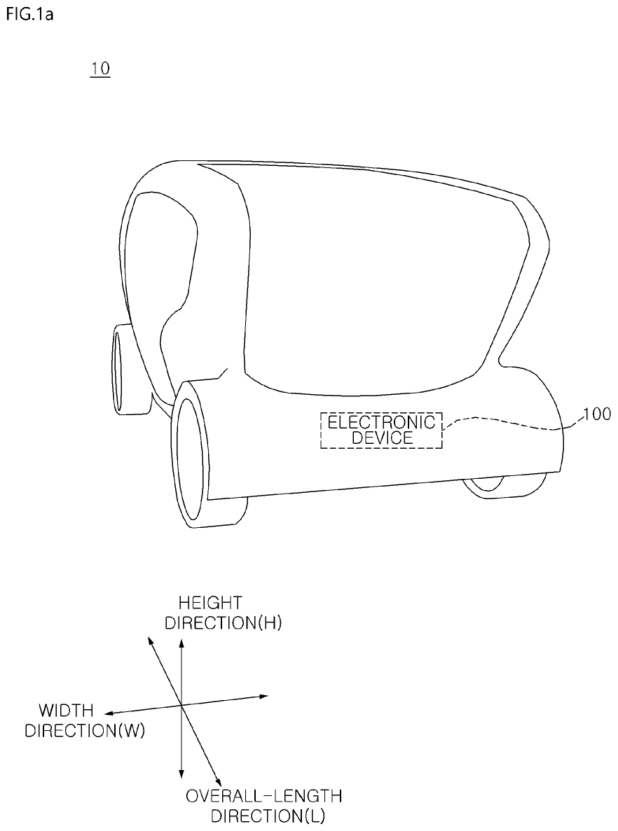

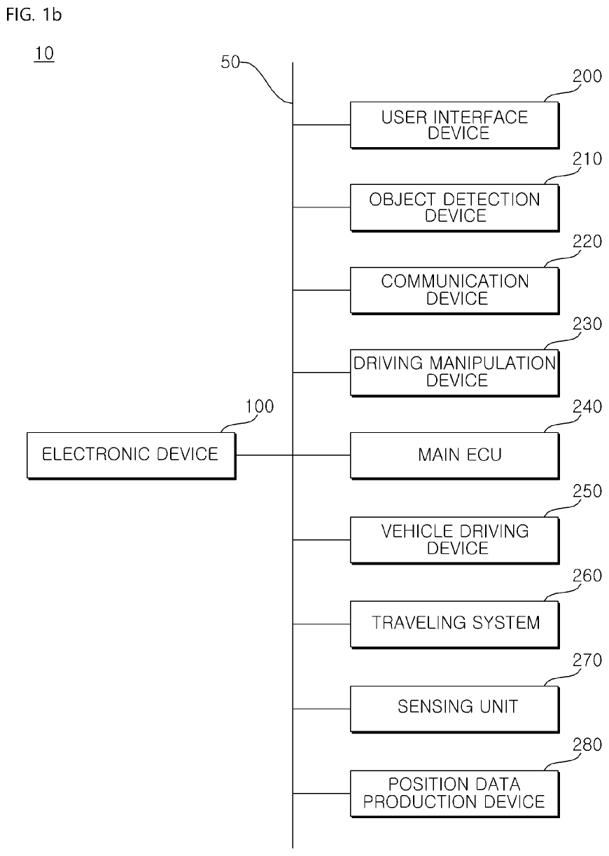

FIG. 1A is a view illustrating an appearance of a vehicle according to an embodiment of the present invention.

Referring to FIG. 1A, the vehicle 10 according to the embodiment of the present invention is defined as a transportation means to travel on a road or a railway line. The vehicle 10 is a concept including an automobile, a train, and a motorcycle. The vehicle 10 may be a concept including all of an internal combustion engine vehicle including an engine as a power source, a hybrid vehicle including an engine and an electric motor as a power source, an electric vehicle including an electric motor as a power source, etc. The vehicle 10 may be a shared vehicle. The vehicle 10 may be an autonomous vehicle. An electronic device 100 may be included in the vehicle 10.

Meanwhile, the vehicle 10 may co-operate with at least one robot. The robot may be an autonomous mobile robot (AMR) which is autonomously movable. The mobile robot is configured to be autonomously movable and, as such, is freely movable. The mobile robot may be provided with a plurality of sensors to enable the mobile robot to bypass an obstacle during travel and, as such, may travel while bypassing obstacles. The mobile robot may be a flying robot (for example, a drone) including a flying device. The mobile robot may be a wheeled robot including at least one wheel, to move through rotation of the wheel. The mobile robot may be a leg type robot including at least one leg, to move using the leg.

The robot may function as an apparatus for supplementing user convenience. For example, the robot may perform a function for transporting a load carried in the vehicle 10 to a user's final destination. For example, the robot may perform a function for guiding a way to a final destination to the user having exited the vehicle 10. For example, the robot may perform a function for transporting the user having exited the vehicle 10 to a final destination.

At least one electronic device included in the vehicle may perform communication with the robot through a communication device 220.

At least one electronic device included in the vehicle may provide, to the robot, data processed in at least one electronic device included in the vehicle. For example, at least one electronic device included in the vehicle may provide, to the robot, at least one of object data, HD map data, vehicle state data, vehicle position data or driving plan data.

At least one electronic device included in the vehicle may receive, from the robot, data processed in the robot. At least one electronic device included in the vehicle may receive at least one of object data, HD map data, vehicle state data, vehicle position data or driving plan data produced from the robot.

At least one electronic device included in the vehicle may generate a control signal further based on data received from the robot. For example, at least one electronic device included in the vehicle may compare information as to an object produced in an object detection device 210 with information as to an object produced by the robot, and may generate a control signal based on compared results. At least one electronic device included in the vehicle may generate a control signal in order to prevent interference between a travel path of the vehicle 10 and a travel path of the robot.

At least one electronic device included in the vehicle may include a software module or a hardware module (hereinafter, an artificial intelligence (AI) module) realizing artificial intelligence. At least one electronic device included in the vehicle may input acquired data to the artificial intelligence module, and may use data output from the artificial intelligence module.

The artificial intelligence module may execute machine learning of input data, using at least one artificial neural network (ANN). The artificial intelligence module may output driving plan data through machine learning of input data.

At least one electronic device included in the vehicle may generate a control signal based on data output from the artificial intelligence module.

In accordance with an embodiment, at least one electronic device included in the vehicle may receive data processed through artificial intelligence from an external device via the communication device 220. At least one electronic device included in the vehicle may generate a control signal based on data processed through artificial intelligence.

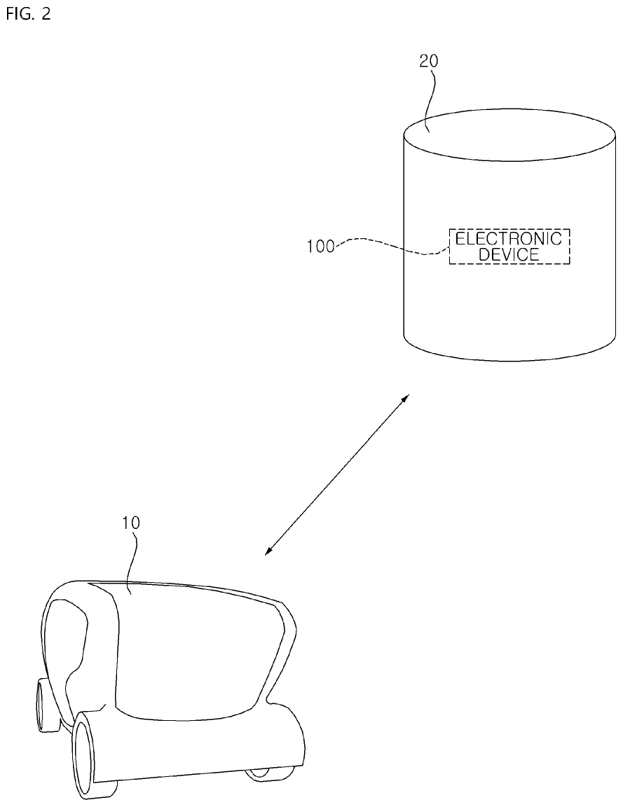

FIG. 2 is a control block diagram of the vehicle according to an embodiment of the present invention.

Referring to FIG. 2, the vehicle 10 may include the electronic device 100, a user interface device 200, the object detection device 210, the communication device 220, a driving manipulation device 230, a main electronic control unit (ECU) 240, a vehicle driving device 250, a traveling system 260, a sensing unit 270, and a position data production device 280.

The electronic device 100 may manage energy of a main mobile body and at least one sub mobile body. The electronic device 100 may provide a path of the main mobile body. The electronic device 100 may provide a path of at least one sub mobile body.

The user interface device 200 is a device for enabling communication between the vehicle 10 and the user. The user interface device 200 may receive user input, and may provide information produced in the vehicle 10 to the user. The vehicle 10 may realize user interface (UI) or user experience (UX) through the user interface device 200.

The object detection device 210 may detect an object outside the vehicle 10. The object detection device 210 may include at least one sensor capable of detecting an object outside the vehicle 10. The object detection device 210 may include at least one of a camera, a radar, a lidar, an ultrasound sensor or an infrared sensor. The object detection device 210 may provide data as to an object produced based on a sensing signal generated in the sensor to at least one electronic device included in the vehicle.

The camera may produce information as to an object outside the vehicle 10, using an image. The camera may include at least one image sensor, and at least one processor electrically connected to the image sensor, to process a signal received from the image sensor and to produce data as to an object based on the processed signal.

The camera may be at least one of a mono camera, a stereo camera, or an around view monitoring (AVM) camera. Using various image processing algorithms, the camera may acquire position information of an object, information as to a distance from the object or information as to a relative speed with respect to the object. For example, the camera may acquire information as to a distance from an object and information as to a relative speed with respect to the object from an acquired image, based on a variation in the size of the object according to time. For example, the camera may acquire distance information and relative speed information associated with an object through a pin hole model, road surface profiling, etc. For example, the camera may acquire distance information and relative speed information associated with an object from a stereo image acquired in a stereo camera, based on disparity information.

In order to photograph an outside of the vehicle, the camera may be mounted at a position in the vehicle where the camera can secure a field of view (FOV). In order to acquire an image in front of the vehicle, the camera may be disposed in an inner compartment of the vehicle in the vicinity of a front windshield. The camera may be disposed around a front bumper or a radiator grill. In order to acquire an image in rear of the vehicle, the camera may be disposed in the inner compartment of the vehicle in the vicinity of a rear glass. The camera may be disposed around a rear bumper, a trunk or a tail gate. In order to acquire an image at a lateral side of the vehicle, the camera may be disposed in the inner compartment of the vehicle in the vicinity of at least one of side windows. Alternatively, the camera may be disposed around a side mirror, a fender, or a door.

The radar may produce information as to an object outside the vehicle 10 using radio waves. The radar may include an electromagnetic wave transmitter, an electromagnetic wave receiver, and at least one processor electrically connected to the electromagnetic wave transmitter and the electromagnetic wave receiver, to process a received signal and to produce data as to an object based on the processed signal. The radar may be embodied through a pulse radar system or a continuous wave radar system based on a radio wave emission principle. The radar may be embodied through a frequency modulated continuous wave (FMCW) system or a frequency shift keying (FSK) system selected from continuous wave radar systems in accordance with a signal waveform. The radar may detect an object, a position of the detected object, and a distance and a relative speed with respect to the detected object by means of an electromagnetic wave on the basis of time of flight (TOF) or phase shift. The radar may be disposed at an appropriate position outside the vehicle in order to sense an object disposed at a front, rear or lateral side of the vehicle.

The lidar may produce information as to an object outside the vehicle 10, using laser light. The lidar may include an optical transmitter, an optical receiver, and at least one processor electrically connected to the optical transmitter and the optical receiver, to process a received signal and to produce data as to an object based on the processed signal. The lidar may be embodied through a time-of-flight (TOF) system and a phase shift system. The lidar may be implemented in a driven manner or a non-driven manner. When the lidar is implemented in a driven manner, the lidar may detect an object around the vehicle 10 while being rotated by a motor. When the lidar is implemented in a non-driven manner, the lidar may detect an object disposed within a predetermined range with reference to the vehicle by optical steering. The vehicle 100 may include a plurality of non-driven lidars. The lidar may detect an object, a position of the detected object, and a distance and a relative speed with respect to the detected object by means of laser light on the basis of time of flight (TOF) or phase shift. The lidar may be disposed at an appropriate position outside the vehicle in order to sense an object disposed at a front, rear or lateral side of the vehicle.

The communication device 220 may exchange a signal with a device disposed outside the vehicle 10. The communication device 220 may exchange a signal with at least one of infrastructure (for example, a server or a broadcasting station) or another vehicle. The communication device 220 may include at least one of a transmission antenna, a reception antenna, a radio frequency (RF) circuit or an RF element capable of implementing various communication protocols in order to execute communication. The communication device 220 may receive a signal, information or data from the sub mobile body. The communication device 220 may transmit a signal, information or data to the sub mobile body.

The communication device 220 may communicate with a device disposed outside the vehicle 10, using a 5G (for example, new radio (NR)) system. The communication device 220 may implement V2X (V2V, V2D, V2P or V2N) communication using the 5G system.

The driving manipulation device 230 is a device for receiving user input for driving. In a manual mode, the vehicle 10 may be driven based on a signal provided by the driving manipulation device 230. The driving manipulation device 230 may include a steering input device (for example, a steering wheel), an acceleration input device (for example, an accelerator pedal), and a brake input device (for example, a brake pedal).

The main ECU 240 may control overall operation of at least one electronic device included in the vehicle 10.

The driving control device 250 is a device for electrically controlling various vehicle driving devices in the vehicle 10. The driving control device 250 may include a powertrain driving control device, a chassis driving control device, a door/window driving control device, a safety device driving control device, a lamp driving control device, and an air conditioner driving control device. The powertrain driving control device may include a power source driving control device and a transmission driving control device. The chassis driving control device may include a steering driving control device, a brake driving control device, and a suspension driving control device.

Meanwhile, the safety device driving control device may include a safety belt driving control device for safety belt control.

The vehicle driving control device 250 may be referred to as a “control electronic control unit (ECU)”.

The traveling system 260 may control motion of the vehicle 10 or may generate a signal for outputting information to the user, based on data as to an object received from the object detection device 210. The traveling system 260 may provide the generate signal to at least one of the user interface device 200, the main ECU 240 or the vehicle driving device 250.

The traveling system 260 may be a concept including an advanced driver-assistance system (ADAS). The ADAS 260 may embody an adaptive cruise control (ACC) system, an autonomous emergency braking (AEB) system, a forward collision warning (FCW) system, a lane keeping assist (LKA) system, a lane change assist (LCA) system, a target following assist (TFA) system, a blind sport detection (BSD) system, an adaptive high beam assist (HBA) system, an auto-parking system (APS), a pedestrian (PD) collision warning system, a traffic sign recognition (TSR) system, a traffic sign assist (TSA) system, a night vision (NV) system, a driver status monitoring (DSM) system, or a traffic jam assist (TJA) system.

The traveling system 260 may include an autonomous electronic control unit (ECU). The autonomous ECU may set an autonomous travel path based on data received from at least one of other electronic devices in the vehicle 10. The autonomous ECU may set an autonomous travel path based on data received from at least one of the user interface device 200, the object detection device 210, the communication device 220, the sensing unit 270, or the position data production device 280. The autonomous traveling ECU may generate a control signal to enable the vehicle 10 to travel along the autonomous travel path. The control signal generated from the autonomous traveling ECU may be provided to at least one of the main ECU 240 or the vehicle driving device 250.

The sensing unit 270 may sense a state of the vehicle. The sensing unit 270 may include at least one of an inertial navigation unit (IMU) sensor, a collision sensor, a wheel sensor, a speed sensor, a slope sensor, a weight sensor, a heading sensor, a position module, a vehicle forward/backward movement sensor, a battery sensor, a fuel sensor, a tire sensor, a handle-rotation-based steering sensor, an internal vehicle temperature sensor, an internal vehicle humidity sensor, an ultrasonic sensor, an ambient light sensor, an accelerator pedal position sensor, or a brake pedal position sensor. Meanwhile, the inertial navigation unit (IMU) sensor may include at least one of an acceleration sensor, a gyro sensor, or a magnetic sensor.

The sensing unit 270 may produce vehicle state data based on a signal generated from at least one sensor. The sensing unit 270 may acquire sensing signals as to vehicle posture information, vehicle motion information, vehicle yaw information, vehicle roll information, vehicle pitch information, vehicle collision information, vehicle direction information, vehicle angle information, vehicle speed information, vehicle acceleration information, vehicle inclination information, vehicle forward/backward movement information, battery information, fuel information, tire information, vehicle lamp information, internal vehicle temperature information, internal vehicle humidity information, a steering wheel rotation angle, ambient illumination outside the vehicle, a pressure applied to the accelerator pedal, a pressure applied to the brake pedal, etc.

In addition, the sensing unit 270 may further include an accelerator pedal sensor, a pressure sensor, an engine speed sensor, an air flow sensor (AFS), an intake air temperature sensor (ATS), a water temperature sensor (WTS), a throttle position sensor (TPS), a top dead center (TDC) sensor, a crank angle sensor (CAS), etc.

The sensing unit 270 may produce vehicle state information based on sensing data. The vehicle state information may be information produced based on data sensed by various sensors included in the vehicle.

For example, the vehicle state information may include vehicle posture information, vehicle speed information, vehicle inclination information, vehicle weight information, vehicle direction information, vehicle battery information, vehicle fuel information, vehicle tire air pressure information, vehicle steering information, internal vehicle temperature information, internal vehicle humidity information, pedal position information, vehicle engine temperature information, etc.

Meanwhile, the sensing unit may include a tension sensor. The tension sensor may generate a sensing signal based on a tension state of a safety belt.

The position data production device 280 may produce position data of the vehicle 10. The position data production device 280 may include at least one of a global positioning system (GPS) or a differential global positioning system (DGPS). The position data production device 280 may produce position data of the vehicle 10 based on a signal generated from at least one of the GPS or the DGPS. In accordance with an embodiment, the position data production device 280 may correct position data based on at least one of an internal measurement unit (IMU) of the sensing unit 270 or a camera of the object detection device 210.

The position data production device 280 may be referred to as a “position measurement device”. The position data production device 280 may be referred to as a “global navigation satellite system (GNSS)”.

The vehicle 10 may include an inner communication system 50. Plural electronic devices included in the vehicle 10 may exchange a signal via the inner communication system 50. Data may be included in the signal. The inner communication system 50 may utilize at least one communication protocol (for example, CAN, LIN, FlexRay, MOST, or Ethernet).

FIG. 2 is a view referred to for explanation of a system according to an embodiment of the present invention.

Referring to FIG. 2, the vehicle 10 may communicate with an external server 20. The vehicle 10 may receive data from the external server. The external server 20 may receive data from the vehicle 10. The external server 20 may include the electronic device 100. The electronic device 100 may manage energy of the main mobile body and at least one sub mobile body. The electronic device 100 may provide a path of the main mobile body. The electronic device 100 may provide a path of at least one sub mobile body.

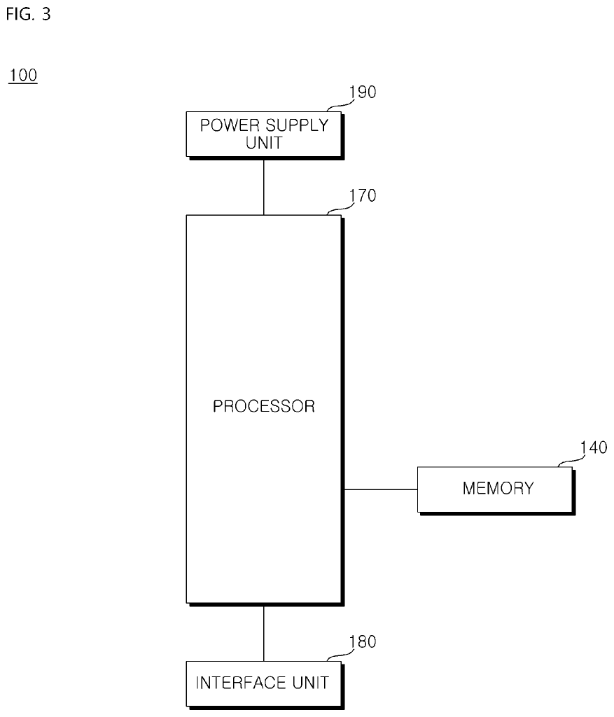

FIG. 3 is a control block diagram of the electronic device according to an embodiment of the present invention.

Referring to FIG. 3, the electronic device 100 may include a memory 140, at least one processor 170, an interface unit 180, and a power supply unit 190.

The memory 140 is electrically connected to the processor 170. The memory 140 may store basic data as to units, control data for unit operation control, and input and output data. The memory 140 may store data processed by the processor 170. The memory 140 may be constituted in a hardware manner by at least one of a read only memory (ROM), a random access memory (RAM), an erasable programmable read-only memory (EPROM), a flash drive, or a hard drive. The memory 140 may store various data for overall operation of the electronic device 100 including a program for processing or controlling the processor 170, etc. The memory 140 may be embodied as being integrated with the processor 170. In accordance with an embodiment, the memory 140 may be classified into a lower-level configuration of the processor 170.

The interface unit 180 may exchange a signal with at least one electronic device included in the vehicle 10 in a wired or wireless manner. The interface unit 280 may exchange a signal in a wired or wireless manner with at least one of the object detection device 210, the communication device 220, the driving manipulation device 230, the main ECU 140, the vehicle driving device 250, the ADAS 260, the sensing unit 170, or the position data production device 280. The interface unit 280 may be constituted by at least one of a communication module, a terminal, a pin, a cable, a port, a circuit, an element, or a device.

The interface unit 180 may receive position data of the vehicle 10 from the position data production device 280. The interface unit 180 may receive travel speed data from the sensing unit 270. The interface unit 180 may receive vehicle surrounding object data from the object detection device 210.

The power supply unit 190 may supply electric power to the electronic device 100. The power supply unit 190 may receive electric power from a power source (for example, a battery) included in the vehicle 10 and, as such, may supply electric power to each unit of the electronic device 100. The power supply unit 190 may operate in accordance with a control signal supplied from the main ECU 140. The power supply unit 190 may be embodied using a switched-mode power supply (SMPS).

The processor 170 may be electrically connected to the memory 140, the interface unit 280, and the power supply unit 190, and, as such, may exchange a signal therewith. The processor 170 may be embodied using at least one of application specific integrated circuits (ASICs), digital signal processors (DSPs), digital signal processing devices (DSPDs), programmable logic devices (PLDs), field programmable gate arrays (FPGAs), controllers, microcontrollers, microprocessors, or electrical units for execution of other functions.

The processor 170 may be driven by electric power supplied from the power supply unit 190. In a state in which electric power from the power supply unit 190 is supplied to the processor 170, the processor 170 may receive data, process the data, generate a signal, and supply the signal.

The processor 170 may receive information from other electronic devices in the vehicle 10 via the interface unit 180. The processor 170 may supply a control signal to other electronic devices in the vehicle 10 via the interface unit 180.

The processor 170 may acquire movement path data of at least one sub mobile body loaded in the main mobile body. For example, the processor 170 may receive movement path data of the sub mobile body from a server (“20” in FIG. 2). For example, the processor 170 may produce movement path data of the sub mobile body. The movement path data may include data as to a movement path of the sub mobile body from a predetermined unloading point to a target point. The movement path data may include data as to a movement path of the sub mobile body from a target point to a predetermined loading point.

The main mobile body may include at least one recharging device for recharging the sub mobile body. The main mobile body may provide recharging energy to the sub mobile body through the recharging device. Recharging operation of the main mobile body through the recharging device may be achieved based on a signal supplied from the electronic device. The main mobile body may provide energy stored in an energy storage device (for example, an electrical energy storage device) included in the main mobile body.

Meanwhile, the recharging device included in the main mobile body may provide energy (for example, electrical energy) to the sub mobile body in a wireless or wired manner.

The processor 170 may acquire residual delivery article information. The processor 170 may produce movement path data of the sub mobile body based on the residual delivery article information. The residual delivery article information may include information as to the number of the residual delivery articles and delivery place information of the residual delivery articles.

The main mobile body may be an autonomous vehicle to move along a global path. The global path may be understood as a path created in the server or the autonomous vehicle in order to guide movement of the autonomous vehicle for delivery of articles. The global path may be created on the basis of a lane. The sub mobile body may be a robot for article delivery moving along a local path. The local path may be understood as a path created in the server or the autonomous vehicle in order to guide movement from a predetermined unloading point to a target point, for guidance of movement of an article delivery robot for article delivery.

The processor 170 may receive first residual energy amount information of the sub mobile body in a state in which the sub mobile body is loaded in the main mobile body. For example, the processor 170 may receive the first residual energy amount information from the sub mobile body. For example, the processor 170 may receive the first residual energy amount information from the server (“20” in FIG. 2). The first residual energy amount information may be defined as residual energy amount information of the sub mobile body in a state in which the sub mobile body is loaded in the main mobile body.

The processor 170 may determine a sub mobile body to be recharged from among a plurality of sub mobile bodies. The processor 170 may acquire information as to the amount of energy required during movement of the sub mobile body from a predetermined unloading point to a target point. The predetermined unloading point may be understood as a position where the sub mobile body is separated from the main mobile body in order to deliver an article. The predetermined unloading point may be determined to be a position capable of minimizing the amount of energy consumed by the main mobile body and the sub mobile body. The target point may be understood as a position where the sub mobile body delivers an article after movement. The required energy amount may include the amount of energy consumed during movement from the predetermined unloading point to the target point. The required energy amount may include the amount of energy consumed during movement from the target point to a predetermined loading point. The processor 170 may determine a sub mobile body to be recharged based on the required energy amount and the first residual energy amount information.

The processor 170 may determine a sub mobile body to be recharged from among a plurality of sub mobile bodies based on whether or not a sufficient amount of energy can be recharged within a time for which the main mobile body moves to the predetermined unloading point.

The processor 170 may provide a control signal to enable a sub mobile body to be recharged during movement of the main mobile body to a predetermined unloading point of the sub mobile body. It is necessary to secure a required energy amount needed for movement of the sub mobile body from the predetermined unloading point to the target point before the main mobile body arrives at the predetermined unloading point. The processor 170 may determine a sub mobile body capable of securing a required energy amount at the predetermined unloading point from among a plurality of sub mobile bodies, based on the required energy amount information and the first residual energy amount information. In this case, the processor 170 may determine the sub mobile body to be recharged, further based on information as to a time taken for the main mobile body to move to the predetermined unloading point.

The processor 170 may determine a recharging amount based on the movement path data and the first residual energy amount information. For example, the processor 170 may determine a recharging amount enabling the sub mobile body to move along a movement path thereof. For example, the processor 170 may determine, as the recharging amount, an energy amount obtained by deducting a first residual energy amount from a total energy amount need for movement of the sub mobile body along the movement path thereof. The processor 170 may acquire information as to a required energy amount needed for movement of the main mobile body to a recharging station thereof, and may determine the recharging amount, further based on the acquired required energy amount. The processor 170 may determine the recharging amount such that an energy amount needed for movement of the main mobile body to the recharging station is left.

The processor 170 may compare the recharging amount with an energy amount which can be provided by the main mobile body. Upon determining that the recharging amount is greater than the energy amount which can be provided by the main mobile body, the processor 170 may create a path for movement of the main mobile body to the recharging station. Upon determining that the recharging amount is greater than the energy amount which can be provided, the processor 170 may generate a control signal to unload the sub mobile body. In this case, the unloaded sub mobile body may be picked up by another main mobile body.

When the recharging amount is equal to or lower than the energy amount which can be provided, the processor 170 may provide a control signal to enable the sub mobile body to be recharged to the recharging amount.

The processor 170 may provide data as to a movement path of the sub mobile body from the predetermined unloading point to the target point. The processor 170 may receive second residual energy amount information of the sub mobile body in an unloaded state of the sub mobile body. For example, the processor 170 may receive the second residual energy amount information from the sub mobile body through wireless communication. For example, the processor 170 may receive the second residual energy amount information from the server (“20” in FIG. 2). The second residual energy amount information may be defined as residual energy amount information of the sub mobile body in a state in which the sub mobile body is unloaded from the main mobile body. The processor 170 may determine whether the sub mobile body can arrive at the target point, based on the second residual energy amount information. For example, the processor 170 may determine whether the sub mobile body can arrive at the target point, based on whether or not the sub mobile body has a sufficient residual energy amount to enable the sub mobile body to arrive at the target point. Upon determining that the sub mobile body cannot arrive at the target point, the processor 170 may provide a path for returning the sub mobile body to the main mobile body.

The processor 170 may provide data as to a movement path from the target point to a predetermined loading point of the sub mobile body. The processor 170 may receive the second residual energy amount information of the sub mobile body in a state in which the sub mobile body is unloaded. For example, the processor 170 may receive the second residual energy amount information from the sub mobile body through wireless communication. For example, the processor 170 may receive the second residual energy amount information from the server (“20” in FIG. 2). The second residual energy amount information may be defined as residual energy amount information of the sub mobile body in a state in which the sub mobile body is unloaded. The processor 170 may determine whether the sub mobile body can arrive at the predetermined loading point, based on the second residual energy amount information. For example, the processor 170 may determine whether or not the sub mobile body can arrive at the predetermined loading point, based on whether or not the sub mobile body has a sufficient residual energy amount to enable the sub mobile body to arrive at the predetermined loading point. Upon determining that the sub mobile body cannot arrive at the predetermined loading point, the processor 170 may change the predetermined loading point. The processor 170 may change the movement path of the sub mobile body by changing the predetermined loading point.

The electronic device 100 may include at least one printed circuit board (PCB). The memory 140, the interface unit 180, the power supply unit 190 and the processor 170 may be electrically connected to the printed circuit board.

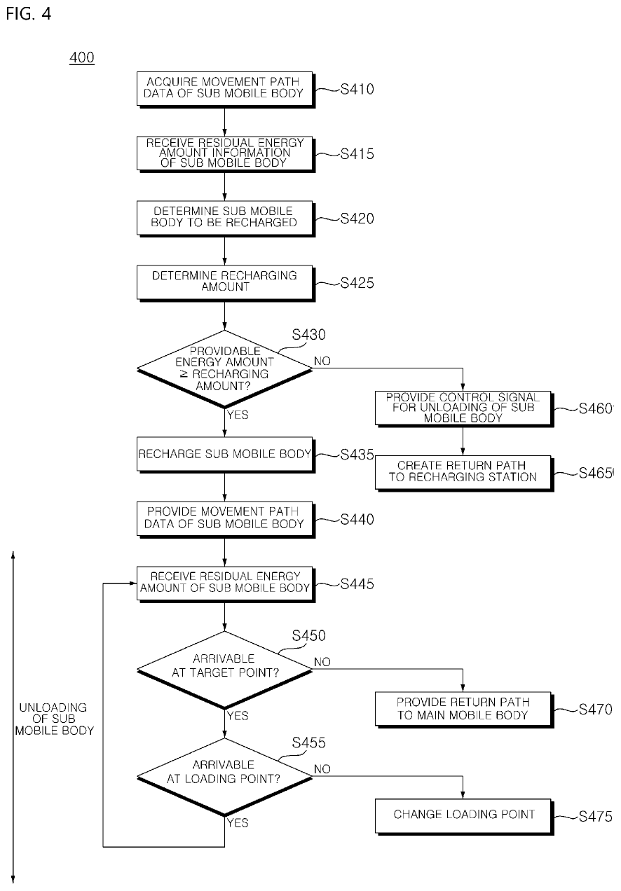

FIG. 4 is a flowchart of the electronic device according to an embodiment of the present invention.

Referring to FIG. 4, the processor 170 may acquire movement path data of at least one sub mobile body loaded in the main mobile body (S410). The main mobile body may be an autonomous vehicle moving along a global path. The sub mobile body may be an article delivery robot moving along a local path. The acquisition step S410 may include steps of, by at least one processor 170, acquiring residual delivery article information, and producing movement path data based on the residual delivery article information. The residual delivery article information may include information as to the number of residual delivery articles and information as to delivery places of the residual delivery articles.

The processor 170 may receive first residual energy amount information from the sub mobile body in a state in which the sub mobile body is loaded in the main mobile body (S415).

The processor 170 may determine a sub mobile body to be recharged from among a plurality of sub mobile bodies (S420). The step S420 of determining a sub mobile body to be recharged may include steps of acquiring, by at least one processor 170, information as to the amount of energy required during movement of each sub mobile body from a predetermined unloading point thereof to a target point thereof, and determining, by at least one processor 170, a sub mobile body to be recharged based on the required energy amount and the first residual energy amount information.

The processor 170 may determine a recharging amount of the sub mobile body to be recharged based on the movement path data and the first residual energy amount information (S425). The step S425 of determining the recharging amount may include steps of acquiring, by at least one processor 170, information as to a required energy amount needed for movement of the main mobile body to a recharging station thereof, and determining, by at least one processor 170, the required recharging amount, further based on the acquired required energy amount. The processor 170 may compare the recharging amount with an energy amount which can be provided by the main mobile body (S430).

When the recharging amount is greater than the energy amount which can be provided by the main mobile body, the processor 170 may generate a control signal to recharge the sub mobile body to the recharging amount (S435).

The processor 170 may provide movement path data of the sub mobile body (S440). The processor 170 may provide data as to a movement path from a predetermined unloading point of the sub mobile body to a target point of the sub mobile body. The processor 180 may provide data as to a movement path from the target point of the sub mobile body to a predetermined loading point of the sub mobile body.

The processor 170 may receive second residual energy amount information of the sub mobile body in an unloaded state of the sub mobile body (S445).

The processor 170 may determine whether the sub mobile body can arrive at the target point, based on the second residual energy amount information (S450).

Upon determining that the sub mobile body cannot arrive at the target point, the processor 170 may provide a path for returning the sub mobile body to the main mobile body (S470).

The processor 170 may determine whether the sub mobile body can arrive at a predetermined loading point, based on the second residual energy amount information (S455).

Upon determining that the sub mobile body cannot arrive at the predetermined loading point, the processor 170 may change the predetermined loading point (S475).

On the other hand, upon determining, at step S430, that the recharging amount is greater than the energy amount which can be provided by the main mobile body, the processor 170 may create a path for movement of the main mobile body to the recharging station (S460).

Meanwhile, upon determining, at step S430, that the recharging amount is greater than the energy amount which can be provided by the main mobile body, the processor 170 may generate a control signal to unload the sub mobile body.

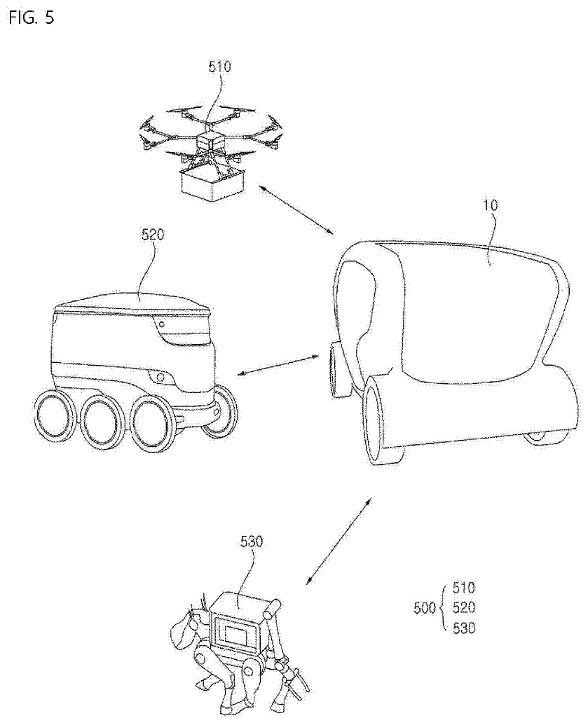

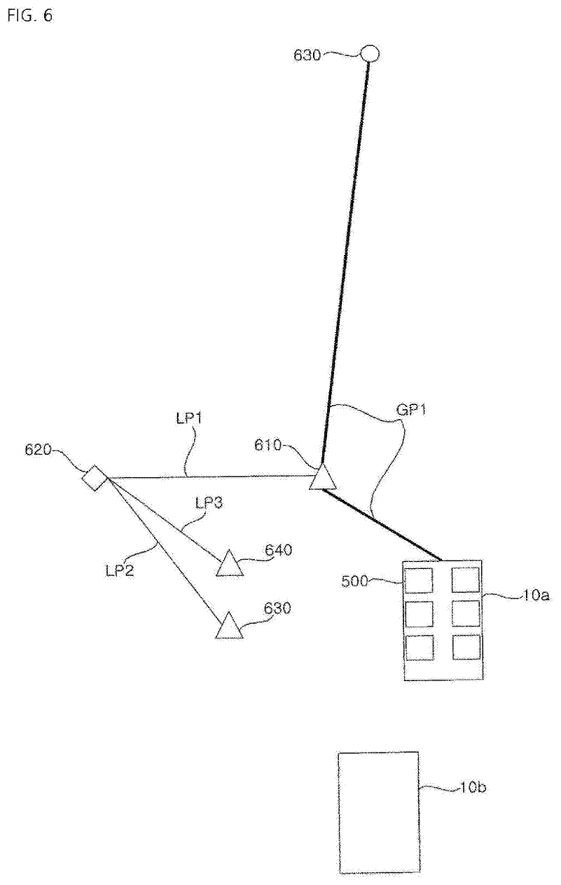

FIGS. 5 and 6 are views referred to for explanation of operation of the electronic device according to an embodiment of the present invention.

Referring to FIG. 5, the main mobile body 10 may be an autonomous vehicle to travel along a global path. The global path may be created in the autonomous vehicle 10 or may be provided from the server (“20” in FIG. 2).

The main mobile body 10 may exchange a signal with a sub mobile body 500 in a wireless or wired manner. The main mobile body 10 may exchange a signal with the sub mobile body 500 through the communication device 220. The sub mobile body 500 may include a communication device in order to exchange a signal with the main mobile body 10. When the electronic device 100 is included in the main mobile body 10, the electronic device 100 may receive a signal, information or data from the sub mobile body 500 via the communication device 220. When the electronic device 100 is included in the main mobile body 10, the electronic device 100 may transmit a signal, information or data to the sub mobile body 500 via the communication device 220. When the electronic device 100 is included in the server (“20” in FIG. 2), the electronic device 100 may receive a signal, information or data from at least one of the main mobile body 10 or the sub mobile body 500 via a communication device of the server. When the electronic device 100 is included in the server (“20” in FIG. 2), the electronic device 100 may transmit a signal, information or data to at least one of the main mobile body 10 or the sub mobile body 500 via the communication device of the server.

The main mobile body 10 may be provided with a space for receiving at least one sub mobile body 500. The main mobile body 10 may be moved in a state of loading the sub mobile body 500 therein.

The main mobile body 10 may include an energy storage device. The main mobile body 10 may be moved by energy stored in the energy storage device. Here, the energy is preferably electrical energy without being limited to a specific one. The main mobile body 10 may include at least one energy transmitting device for transmitting energy to the sub mobile body 500 in a wireless or wired manner. The main mobile body 10 may provide recharging energy to the sub mobile body 500 through the energy transmitting device in a wireless or wired manner. The recharging energy may be energy stored in the energy storage device. Supply of recharging energy may be achieved in a state in which the sub mobile body 500 is loaded in the main mobile body 10.

The main mobile body 10 may be recharged in a recharging station in a wireless or wired manner. The main mobile body 10 may include an energy receiving device for receiving energy in the recharging station. The energy receiving device may be formed to be integrated with the energy transmitting device.

The sub mobile body 500 may be an article delivery robot to move along a local path. The local path may be created in the autonomous vehicle 10, may be created in the sub mobile body 500, or may be provided by the server (“20” in FIG. 2). The sub mobile body 500 may move a global path in a state of being loaded in the main mobile body 10.

The sub mobile body 500 may be embodied in the form of a flying robot 510. The sub mobile body 500 may be embodied in the form of a vehicle 520 including at least one wheel, to be movable through rotation of the wheel. The sub mobile body 500 may be embodied in the form of a mobile robot 530 including at least one leg, to be movable using the leg.

The sub mobile body 500 may include a portion for loading an article. The sub mobile body 500 may move from an unloading point to a target point in an article-loaded state. The sub mobile body 500 may move from the target point to a loading point. For movement of the sub mobile body 500, energy may be used. The sub mobile body 500 may include an energy storage device capable of storing energy. The sub mobile body 500 may include an energy receiving device for receiving recharging energy from the main mobile body 500 in a wireless or wired manner. The received recharging energy may be stored in the energy storage device.

The main mobile body 10 may acquire global path data. The global path data may be produced in the main mobile body 10. The global path data may be received from the server (“20” in FIG. 2). The sub mobile body 500 may acquire local path data. The local path data may be produced in the main mobile body 10. The local path data may be produced in the sub mobile body 500. The local path data may be received from the server (“20” in FIG. 2). The local path data may be understood as a path extending forwards from the sub mobile body by a predetermined distance. When an obstacle on the path is detected, the local path data may be changed.

The travel strategy of the main mobile body 10 may be defined by four steps. The main mobile body 10 may travel in accordance with the travel strategy defined by four steps, depending on a situation. The first step may be defined as operation of the main mobile body 10 to unload and load the sub mobile body 500 while circulating on a predetermined route. Here, the route is a path received from the server (“20” in FIG. 2), and may include information as to loading/unloading points of the sub mobile body 500. The second step may be defined as operation of the main mobile body 10 to travel after correcting the route or the loading/unloading points while circulating on the predetermined route when there is no sub mobile body 500 movable to a final delivery point. The route to be corrected should not extend beyond a section (a unit segment) between the loading/unloading points of the sub mobile body 500. The corrected loading/unloading points may be notified to an article receiver through the server (“20” in FIG. 2). The third step may be defined as operation of the main mobile body 10 to create a travel route for return to a recharging station after completion of delivery of a loaded article and to travel along the created travel route. The fourth step may be defined as operation of the main mobile body 10 to return to an appropriate recharging station located close thereto, to pick up a sub mobile body 500, to be recharged, on the return route, and to load/unload a sub mobile body 500 required to move along the return route. The appropriate recharging station may be determined in accordance with the recharging capacity of the main mobile body, the number of sub mobile bodies to return (recharging amount), and whether or not there is an article to be sent to another area.

The delivery strategy of the sub mobile body 500 may be defined by three steps. The sub mobile body 500 may travel in accordance with the travel strategy defined by four steps, depending on a situation. The first step may be defined as operation of the sub mobile body 500 to deliver/pick-up at a predetermined delivery/pickup place and to return. Upon return, the sub main body 500 may select an appropriate main mobile body, and may be returned by the selected main mobile body. The appropriate main mobile body may be selected, taking into consideration the distance between the main mobile body and the sub mobile body and a movement environment. The second step may be defined as operation of the sub mobile body 500 to pick up an article placed close to the predetermined delivery place after delivery at the predetermined delivery place, and then to return. The article pickup after delivery may be achieved by searching for an article placed at a pickable distance, taking into consideration an energy recharging amount, after delivery, and then picking up the searched article. The third step may be defined as operation of the sub mobile body 500 to recharge a discharged sub mobile body 500 and then to return together with the recharged sub mobile body 500. When there is a sub mobile body 500 discharged in an unexpected situation, the subject sub mobile body 500 may recharge the discharged sub mobile body 500, and may then return together therewith. Here, the unexpected situation may be explained as the case in which an estimated recharged amount may be rapidly discharged due to abrupt temperature decrease, etc.

Referring to FIG. 6, a first main mobile body 10a may move along a first global path GP1, using energy stored in the energy storage device. The first main mobile body 10a may move in a state of loading at least one sub mobile body 500.

The sub mobile body 500 may move along a first local path LP1 from a predetermined unloading point (or an unloading point) 610 to a target point 620, using energy stored in the energy storage device. The sub mobile body 500 may move along a second local path LP2 from the target point 620 to a predetermined first loading point (or a loading point) 630, using energy stored in the energy storage device. When the predetermined loading point (or the loading point) is changed to a predetermined second loading point (or anther loading point) 640 by the electronic device 100, the sub mobile body 500 may move along a third local path LP3 from the target point 620 to the predetermined second loading point (or another loading point) 630, using energy stored in the energy storage device.

The electronic device 100 may control energy recharging of the sub mobile body 500. Meanwhile, recharging resources may be defined by fourth steps. The electronic device 100 may perform control to recharge the sub mobile body 500 through one of the four steps. The first step may be defined as completely recharging all sub mobile bodies 500. The second step may be defined as recharging the sub mobile body 500 to a recharging amount required to provide a delivery service in an associated area or more. The required recharging amount may be calculated in the electronic device 100. The third step may be defined as recharging a part of the sub mobile bodies 500 to predetermined amounts based on residual delivery article information, respectively. The third step may be executed when it is determined that a predetermined number of sub mobile bodies 500 or more cannot be recharged to a required average recharging amount. The fourth step may be defined as stopping recharging, returning the main mobile bodies 10a and 10b to a recharging station 630 of the main mobile body 500, and completely recharging the main mobile bodies 10a and 10b. The fourth step may be calculated based on a distance from the position of the main mobile body to the recharging station 630.

The present invention as described above may be embodied as computer-readable code, which can be written on a program-stored recording medium. The recording medium that can be read by a computer includes all kinds of recording media, on which data that can be read by a computer system is written. Examples of recording media that can be read by a computer may include a hard disk drive (HDD), a solid state drive (SSD), a silicon disk drive (SDD), a read only memory (ROM), a random access memory (RAM), a CD-ROM, a magnetic tape, a floppy disk, an optical data storage, etc., and may include an embodiment having the form of a carrier wave (for example, transmission over the Internet). In addition, the computer may include a processor or a controller. Accordingly, it will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. An operating method of an electronic device comprising:
acquiring, by at least one processor, movement path data of at least one sub mobile body loaded in a main mobile body;
receiving, by at least one processor, first residual energy amount information of the sub mobile body in a state in which the sub mobile body is loaded in the main mobile body;
determining, by at least one processor, a recharging amount based on the movement path data and the first residual energy amount information; and
providing, by at least one processor, a control signal to enable the sub mobile body to be recharged to the determined recharging amount.

2. The operating method of the electronic device according to claim 1, wherein:
the main mobile body is an autonomous vehicle to move along a global path; and
the sub mobile body is an article delivery robot to move a local path.

3. The operating method of the electronic device according to claim 2, wherein the acquiring comprises:
acquiring, by at least one processor, residual delivery article information; and
producing the movement path data based on the residual delivery article information.

4. The operating method of the electronic device according to claim 3, wherein the residual delivery article information comprises information as to the number of residual delivery articles and information as to delivery places of the residual delivery articles.

5. The operating method of the electronic device according to claim 1, further comprising:
determining, by at least one processor, a sub mobile body to be recharged from among a plurality of sub mobile bodies.

6. The operating method of the electronic device according to claim 5, wherein the determining a sub mobile body to be recharged comprises:
acquiring, by at least one processor, information as to required energy amount during movement of the sub mobile body from a predetermined unloading point to a target point; and
determining, by at least one processor, a sub mobile body to be recharged based on the required energy amount and the first residual energy amount information.

7. The operating method of the electronic device according to claim 1, further comprising:
providing, by at least one processor, the movement path data, data as to a movement path of the sub mobile body from a predetermined unloading point to a target point.

8. The operating method of the electronic device according to claim 7, further comprising:
receiving, by at least one processor, second residual energy amount information of the sub mobile body in an unloaded state of the sub mobile body;
determining, by at least one processor, whether the sub mobile body can arrive at the target point, based on the second residual energy amount information; and
providing, by at least one processor, a path for returning the sub mobile body to the main mobile body upon determining that the sub mobile body cannot arrive at the target point.

9. The operating method of the electronic device according to claim 7, further comprising:
providing, by at least one processor, the movement path data, data as to a movement path of the sub mobile body from the target point to a predetermined loading point.

10. The operating method of the electronic device according to claim 9, further comprising:
receiving, by at least one processor, second residual energy amount information of the sub mobile body in an unloaded state of the sub mobile body;
determining, by at least one processor, whether the sub mobile body can arrive at the predetermined loading point, based on the second residual energy amount information; and
changing, by at least one processor, the predetermined loading point upon determining that the sub mobile body cannot arrive at the predetermined loading point.

11. The operating method of the electronic device according to claim 1, further comprising:
comparing, by at least one processor, the recharging amount with an energy amount which can be provided by the main mobile body; and
creating, by at least one processor, a path for movement of the main mobile body to a recharging station upon determining that the recharging amount is greater than the energy amount which can be provided.

12. The operating method of the electronic device according to claim 11, further comprising:
generating, by at least one processor, a control signal to unload the sub mobile body upon determining that the recharging amount is greater than the energy amount which can be provided.

13. The operating method of the electronic device according to claim 1, wherein the determining a recharging amount comprises:
acquiring, by at least one processor, information as to a required energy amount needed for movement of the main mobile body to a recharging station thereof; and
determining, by at least one processor, the recharging amount, further based on the acquired required energy amount.

14. An electronic device comprising:
a processor that is configured to:
acquire movement path data of at least one sub mobile body loaded in a main mobile body,
receive first residual energy amount information of the sub mobile body in a state in which the sub mobile body is loaded in the main mobile body,
determine a recharging amount based on the movement path data and the first residual energy amount information, and
provide a control signal to enable the sub mobile body to be recharged to the recharging amount.

15. The electronic device according to claim 14, wherein:
the main mobile body is an autonomous vehicle to move along a global path; and
the sub mobile body is an article delivery robot to move a local path.

16. The electronic device according to claim 15, wherein the processor is configured to:
acquire residual delivery article information; and
produce the movement path data based on the residual delivery article information.

17. The electronic device according to claim 16, wherein the residual delivery article information comprises information as to the number of residual delivery articles and information as to delivery places of the residual delivery articles.

18. The electronic device according to claim 14, wherein the processor is configured to determine a sub mobile body to be recharged from among a plurality of sub mobile bodies.

19. The electronic device according to claim 18, wherein the processor is configured to:
acquire information as to required energy amount during movement of the sub mobile body from a predetermined unloading point to a target point; and
determine a sub mobile body to be recharged based on the required energy amount and the first residual energy amount information.

20. The electronic device according to claim 14, wherein the processor is configured to provide the movement path data, data as to a movement path of the sub mobile from a predetermined unloading point to a target point.
